(19) United States
(12) Patent Application Publication
(10) Pub. No.: US 2010/0027417 A1
(43) Pub. Date: Feb. 4, 2010

(54) METHOD AND APPARATUS FOR IMPROVING BANDWITH EXPLOITATION IN REAL-TIME AUDIO/VIDEO COMMUNICATIONS

(76) Inventors: Guido Franceschini, Torino (IT); Stefano Oldrini, Torino (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/308,757

(22) PCT Filed: Jun. 29, 2006
(86) PCT No.: PCT/EP2006/006309

§ 371 Date: Dec. 23, 2008

(51) Int. Cl. H04L 1/20

(52) U.S. Cl. 370/232

(57) ABSTRACT

A method of sending a data flow including a video flow from a sending entity to a receiving entity over a telecommunications network, includes having the sending entity: obtain from the receiving entity information about a downlink bandwidth available for reception of the data flow at the receiving entity side; obtain information about an uplink bandwidth available for the transmission of the data flow at the sending entity side; set transmission parameters of the data flow to be sent to the receiving entity based on the information about the available downlink bandwidth and the available uplink bandwidth; and transmit the data flow in accordance with the set transmission parameters.

### BACKGROUND OF THE INVENTION

1. Field of the Invention

The present invention generally relates to the field of telecommunications, and particularly to real-time audio/video communications in packet-based telecommunications networks, such as networks exploiting the Internet Protocol (IP). More specifically, the invention relates to the bandwidth exploitation in real-time audio/video communications in networks featuring scarce bandwidth availability, like for example in video-telephony over Plain Old Telephone Service (POTS) networks.

2. Description of Related Art

The transition from analog to digital and the diffusion of packet-based, particularly IP-based telecommunications networks, also in the realm of interpersonal communications, has promoted the extension of the traditional, plain voice communications, as enabled by the POTS networks, to audio/video communications.

The video signal differs significantly from the audio signal, and this impacts on the coding techniques adopted to compress the information.

The audio signal, when digitalized, is represented by a continuous flow of samples, each being a single numeric “value” (or a set of values, in the case of stereo or multi-channel audio). Audio samples are typically managed by the encoder in groups of fixed length, and compressed exploiting the similarity among samples within that group: the result of the encoding process is a sequence of audio frames, each providing the coded representation of a group of samples.

The video signal is made instead of a sequence of pictures. Each picture has to be compressed by the encoder, either independently or by exploiting the similarity with adjacent pictures: this technique allows improving significantly the compression efficiency, at the cost of introducing interdependencies between video frames. Differently from the audio case, this technique is widely used in video coding, also for communication services, since the compression gain is very relevant.

The number of video frames that are coded in one second (a parameter called “frames per second”, or “fps”) determines the fluidity of the reproduced video sequence: this parameter should ideally reach 25 or 30, in order to mimic the fluidity of the television signal; however, the more frames are coded in one second, the higher the CPU and bandwidth requirements. For video communications, CPU and bandwidth constraints typically limit the fps figure to a significantly lower value.

Encoder and transmission parameters significantly affect the user experience of a video-communication service. In a communication scenario, the selection of the codecs (the devices/software applications for encoding and decoding audio and video coded flows) and of their parameters is mostly decided through a capability exchange mechanism that sets the interoperability constraints.

Audio encoders typically run at a fixed bit-rate, although exception exists, both because through a Voice Activity Detection tool it is possible to replace the normal coding process with a much more compact representation of silence or comfort noise, and because some codecs can operate at multiple bit rates and switch among such coding modes.

Video encoders can be impacted by a multitude of parameters: among all, the frame size and the frame rate settings, and the bit rate. The frame size is normally fixed for the whole duration of a communication session, and it is set based on the negotiation among the terminals. For many video codecs, frame rate and bit rate can instead be chosen (and also dynamically modified during the communication session) with an autonomous decision of the sending terminal.

At the transmission level different packetization and interleaving techniques might also impact the quality of service, e.g. in terms of end-to-end delay, and portion of bandwidth dedicated to the actual payload.

A widely used, application-layer protocol (according to the OSI—Open System Interconnect—protocol layer model) for setting up and tearing down audio and video communications sessions over IP-based networks is the SIP (Session Initiation Protocol). The SIP works in concert with several other lower-layer protocols, and is involved in the signaling portion of a communication session. In particular, the SIP acts as a carrier for the Session Description Protocol (SDP), which is another application-layer protocol describing the media content of the session, e.g. what IP ports to use, the codec being used etc. In particular, the SIP uses the SDP as a means of capability exchange during the session setup phase. The SDP, described in the IETF (Internet Engineering Task Force) RFC (Request For Comments) 2327, provides a certain amount of information about the supported media. In particular, the SDP defines optional parameters to describe the characteristics of the audio/video flows.

When, after the session set-up, the audio/video data is delivered through an IP network, a number of further protocols, at different layers of the OSI model are involved. According to widely accepted and used standards in the field, the protocol layers stack involves, from the application level down to the physical medium: (i) the Real-time Transport Protocol (RTP), an application-layer protocol that associates meta-information (timestamps, sequence numbers etc.) to each portion of the audio or video payload; (ii) the User Datagram Protocol (UDP), a transport-layer protocol that provides a transport service suitable for real-time delivery (packets are sent once, and not acknowledged: thus, lost packets are not retransmitted, and new packets do not have to wait for retransmission of old ones); (iii) the IP, a network-layer protocol that provides the overall transport service infrastructure (addressing, routing etc.); and (iv) a number of different protocol layers stacks, featuring data link and physical layer functionalities and that depend on the specific network itself.

In the published U.S. patent application 2005/0053055, a method of controlling audio communications on a network for VoIP (Voice over IP) systems is disclosed, that comprises setting a desired maximum and minimum packet size at the source; setting a desired maximum and minimum packet size at the destination; determining a minimum send packet size as the greater of the desired minimum set by the source and the desired minimum set by the destination.

### SUMMARY OF THE INVENTION

The Applicant has observed that a problem that occurs when realizing an audio/video-communication over IP networks with limited bandwidth capacity, like for example video-telephony over POTS, and in general whenever the bandwidth amounts to no more than approximately 40-50 Kb/s, typically 25-30 Kb/s in UpLink (UL) and DownLink (DL), is that of determining the encoding and/or transmission parameters so as to fully exploit the scarce network resources available.

Normally, during an audio/video communication session set-up, some parameters are negotiated between the transmitter and the receiver, some other parameters are chosen by the transmitter based on a prudent, conservative criterion, which is intrinsically not designed to efficiently exploit the available bandwidth.

Indeed, in a scenario wherein the bandwidth capability is a precious resource, an inefficient exploitation thereof jeopardizes the possibility of having an acceptable implementation of real-time audio/video communications.

Based on the fact that, in a communication scenario, the selection of the codecs and of their parameters is not totally entrusted to the above-mentioned capability exchange mechanism, but still leaves quite some space to further autonomous choices at the transmitter, the Applicant has observed that, in order to efficiently exploit the limited available bandwidth, it would be important, for a sending entity, i.e. an entity, like a communications terminal involved in an audio/video communications session and acting as a transmitter of audio/video flow(s) (by “audio/video” there is meant video and, possibly, also audio; thus, “audio/video flow(s)” is to be construed as a video flow, either alone or, possibly, associated with an audio flow), to be capable of taking the most appropriate decision in setting the audio and, especially, the video coding and transmission parameters.

The Applicant has noticed that in order to take the above-mentioned decision, the sending entity should have knowledge of the communication bandwidth available for reception of the audio/video data at the receiving entity side.

Based on the further observation that possible bandwidth bottlenecks generally do not reside within the core of the telecommunications network used for transporting the audio/video flow(s), the Applicant has found that a reasonably precise characterization of the actual network bandwidth available for reception at the receiving entity side can be adopted in order to enable the sending entity taking a decision for setting the audio and, especially, the video coding and transmission parameters in such a way to fully exploit the limited available bandwidth; in addition to this, a knowledge of the network bandwidth available for transmission at the sending entity side can be also adopted.

The sending entity can thus combine the information on the network bandwidth available for reception at the receiving entity side with that of the network bandwidth available for transmission at the transmitting entity side, thereby determining where the bandwidth bottleneck resides, and calculate the optimal transmission (and, possibly, encoding) parameters for a video-communication service.

According to an aspect of the present invention, a method of sending a data flow including a video flow from a sending entity to a receiving entity over a telecommunications network, as set forth in appended claim 1 is provided.

The method comprises having the sending entity:
obtaining from the receiving entity information about a downlink bandwidth available for reception of the data flow at the receiving entity side;
obtaining information about an uplink bandwidth available for the transmission of the data flow at the sending entity side;
setting transmission parameters of the data flow to be sent to the receiving entity based on the information about the available downlink bandwidth and the available uplink bandwidth; and
transmitting the data flow in accordance with the set transmission parameters.

Features of the method that are regarded as preferred albeit not essential are set forth in the dependent claims, which are herein incorporated by reference.

In particular, in addition to the available downlink and uplink bandwidths, another useful parameter for fully exploiting the bandwidth is the overhead introduced by a communications protocol used by the receiving entity, and, possibly, an overhead introduced by a communications protocol used by the sending entity.

In this respect, it is worth pointing out that while in a data flow including only a video flow an indication of the available downlink and uplink bandwidths could be sufficient for setting the parameters for the transmission of the video flow, in a data flow including both audio and video flows the knowledge of the overhead introduced by the communications protocol used by the receiving entity, and, possibly, the overhead introduced by the communications protocol used by the sending entity, is very important for the sending entity. Based on this knowledge, the sending entity can establish the best trade-off between the size of the packets, particularly those transporting the audio flow, and the end-to-end delay. In fact, while on one hand longer audio packets generally reduce the impact of the overhead (so that the audio information transfer rate is increased, and more bandwidth is left for the video flow), on the other hand the end-to-end delay is increased. For example, based on the knowledge of the overhead, the sending entity can determine the benefit of having longer packets, and, if the benefit is significant (i.e., if the saved bandwidth that can be reserved to the video flow is non-negligible), it may decide to accept a higher audio end-to-end delay. It is thus observed that the knowledge of the protocol overhead may in some cases be even more important than the knowledge of the available bandwidth on the downlink and/or the uplink.

According to a second aspect of the present invention, a sending entity as set forth in the appended claim 18 is provided, adapted to send a data flow including a video flow to a receiving entity over a telecommunications network.

The sending entity is adapted to:
obtain from the receiving entity information about a downlink bandwidth available for reception of the data flow at the receiving entity side;
obtain information about an uplink bandwidth available for the transmission of the data flow at the sending entity side;
set transmission parameters of the data flow to be sent to the receiving entity based on the information about the available downlink bandwidth and the available uplink bandwidth; and
transmit the data flow in accordance with the set transmission parameters.

Features of the sending entity that are regarded as preferred albeit not essential are set forth in the dependent claims, which are herein incorporated by reference.

### BRIEF DESCRIPTION OF THE DRAWINGS

The features and advantages of the present invention will be made apparent by reading the following detailed description of some embodiments thereof, provided merely by way of non-limitative example, description that will be conducted making reference for better clarity to the attached drawings, wherein:

FIG. 1 pictorially shows a scenario of a telecommunications system supporting audio/video communications according to the present invention;

FIG. 2 illustrates the SIP signaling between the different players for the set-up of a video-communications session;

FIG. 3 schematically shows exemplary stacks of protocol layers used for delivering an audio/video flow over an IP-based telecommunications network;

FIG. 4 schematically shows an overhead added by uppermost protocol layers down to (and including) the IP layer;

FIG. 5 schematically shows a further overhead added by lowermost protocol layers, below the IP layer, in a first exemplary case;

FIG. 6 schematically shows a further overhead added by lowermost protocol layers, below the IP layer, in a second exemplary case;

FIG. 7 schematically shows, in terms of functional blocks, the main functional components of a terminal adapted to receive an audio/video flow, in an embodiment of the present invention;

FIG. 8 schematically shows, in terms of functional blocks, the main functional components of a terminal adapted to send an audio/video flow, in an embodiment of the present invention;

FIG. 9 shows, in terms of a schematic flowchart, the main actions performed in carrying out a method according to an embodiment of the present invention; and

FIG. 10 shows, in terms of a schematic flowchart, a procedure for calculating optimal encoding and transmission parameters for transmitting an audio/video flow, according to an embodiment of the present invention.

### DETAILED DESCRIPTION OF THE PREFERRED EMBODIMENT

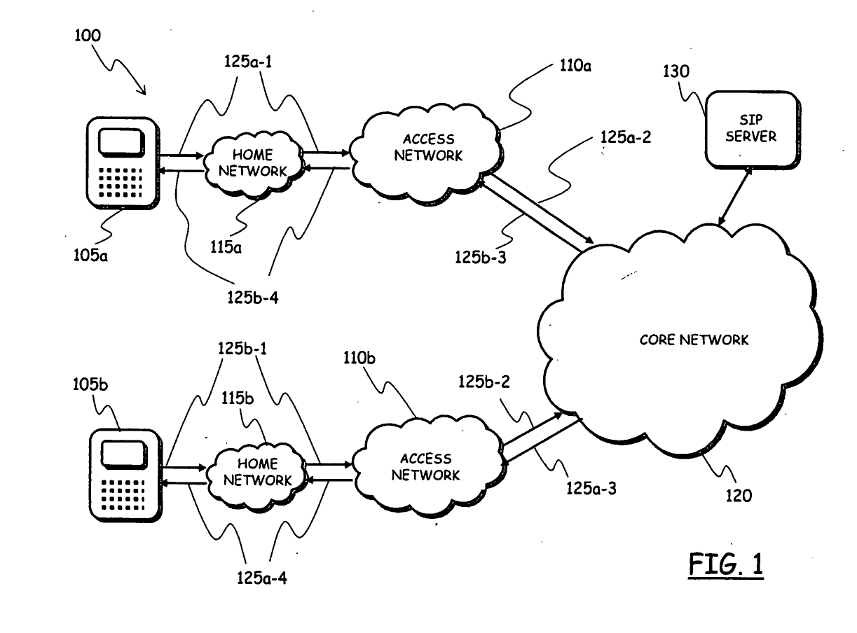

Making reference to the drawings, in FIG. 1 a scenario of a telecommunications system is pictorially shown supporting audio/video communications according to the present invention.

In particular, the telecommunications system of FIG. 1, denoted globally as 100, includes a system of IP-based telecommunication networks, through which two telecommunications terminals 105a and 105b are interconnected. The two telecommunications terminals 105a and 105b may in principle be any kind of telecommunications terminal adapted to support audio/video-communications, like for example second-generation GPRS (General Packet Radio Service) or EDGE (Enhanced Data-rate for GPRS Evolution) or third-generation (e.g., UMTS—Universal Mobile Telecommunications Standard) mobile phones, smart phones, PDAs, personal computers, and the network connecting them may in principle be a wired network, or a wireless network, or a combination thereof. However, the major benefits of the present invention are experienced when at least one or both of the telecommunications terminals 105a and 105b is/are a video-telephony apparatus (shortly, a videophone) adapted to support audio-communications and video-communications over a POTS network, having bandwidth limited to no more than approximately 40-50 Kbs, e.g. about 25-30 Kbs, or other limited-bandwidth network.

In greater detail, the two terminals 105a and 105b are in general connected to respective access networks 110a and 110b through respective home networks 115a and 115b. The access networks 110a and 111b are connected in turn to a core network 120.

From the practical viewpoint, the core network 120 includes an IP-based network, like for example the Internet or an IP-based private core network of a telecom operator; the generic access network 110a, 110b is for example the POTS network that links the user premises, e.g. the user home, to a network central; the generic home network 115a, 115b is for example the radio link between a cordless phone and the respective base plugged into the socket, or a WiFi connection. It is pointed out that, in some cases, either one or both of the home networks 115a and 115b may collapse to nothing, i.e. either one or both of the terminals 105a and 105b may be directly connected to the respective access network 110a and 110b. This is for example the case of a wired videophone attached directly to the POTS network (i.e., plugged into the telephone network socket).

The terminals 105a and 105b can communicate with each other through the concatenation of the networks 115a, 110a, 120, 110b and 115b. The terminal 105a, when assumed to act as an audio/video flow(s) sending (i.e., transmitting) entity can thus deliver a data flow 125a-1, through the home network 115a (when present), to the access network 110a; then, the data flow 125a-1 traverses the access network 110a and reaches, as a data flow 125a-2, the core network 120; then, the data flow 125a-2 traverses the core network 120 and reaches, as a data flow 125a-3, the access network 110b; then, the data flow 125a-3 traverses the access network 110b and reaches, as a data flow 125a-4, the terminal 105b, which in this case acts as the receiving entity, possibly through the home network 115b thereof (when present). Vice versa, the terminal 105b, when assumed to act as the sending entity, can deliver a data flow 125b-1, possibly through the home network 115b, to the access network 110b; then, the data flow 125b-i traverses the access network 110b and reaches, as a data flow 125b-2, the core network 120; then, the data flow 125b-2 traverses the core network 120 and reaches, as a data flow 125b-3, the access network 110a; then, the data flow 125b-3 traverses the access network 110b and reaches, as a data flow 125b-4, the terminal 105a, acting in this case as the receiving entity, possibly through the home network 115a, if present.

It is noticed that the data flow 125a-1, 125a-2, 125a-3, 125a-4 from the terminal 105a to the terminal 105b, as well as the data flow 125b-1, 125b-2, 125b-3, 125b-4 from the terminal 105b to the terminal 105a, at every point of observation, might actually consist of a majority of traffic in the considered direction, and a minority traffic in the reverse direction (this is for example traffic transporting real-time feedback from receiver to transmitter).

The terminals and networks support and allow bidirectional traffic, thus either one of the terminals 105a and 105b may act both as a sending entity and as a receiving entity, i.e. both as a source and as a destination of audio/video flow(s).

When one of the two terminals, e.g. the terminal 105a, wishes to establish a video-communication session with the other terminal 105b, a session set-up procedure is performed. Generally speaking, during the session set-up the terminal that will act as the sender of the audio/video flow(s) sets, inter alia, the audio and video coding and transmission parameters, like for example the frame rate and the bit rate.

As discussed in the foregoing, a widely used, application-layer protocol for setting up and tearing down audio and video communications sessions over IP-based networks is the SIP. In FIG. 1, a SIP server platform 130 is schematically depicted, connected to the core network 120, adapted to route SIP messages; the SIP server platform 130 is intended to represent a SIP infrastructure adapted to communicate using SIP, including for example proxies and one or more SIP servers.

The SIP acts as a carrier for the SDP, which is another application-layer protocol describing the media content of the session, e.g. what IP ports to use, the codec being used etc.

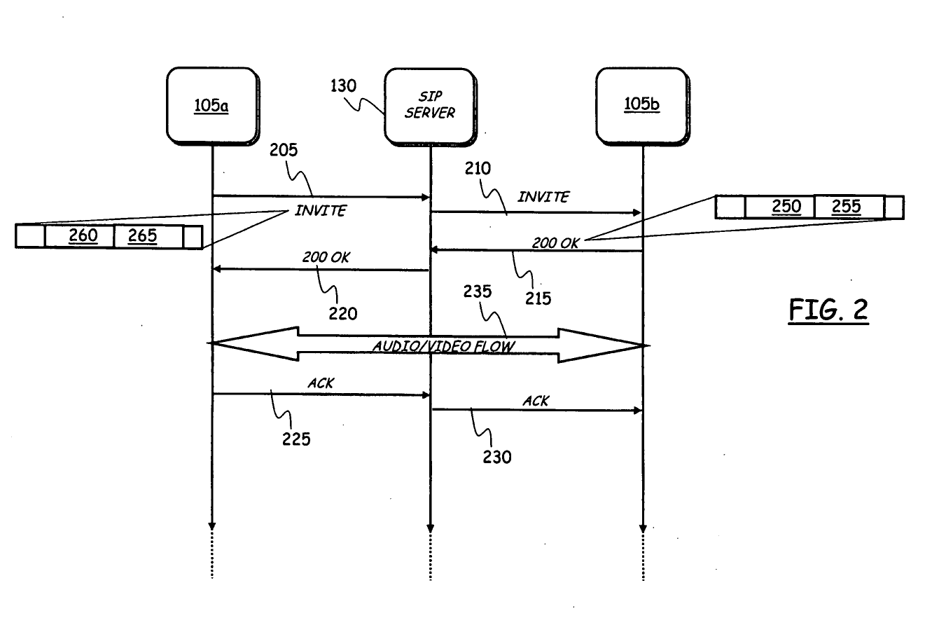

FIG. 2 illustrates, schematically and in a simplified way, the signaling between the terminals 105a and 105b, and the SIP server platform 130 for the set-up of a video-communications session. It is assumed that both the terminals 105a and 105b have already registered themselves at a SIP server of the SIP server platform 130. It is pointed out that FIG. 2 does not show, for the sake of simplicity, the complete flow diagram of a SIP session set-up, nor is it intended to provide details on timeouts or failure conditions. Only the essential SIP messages exchanged by the terminals 105a and 105b at the session setup are shown. Assuming that the session is initiated by the terminal 105a, these messages comprise:
an INVITE message 205 (including a SDP session description), generated by the terminal 105a to invite the terminal 105b to take part to the communications session being established; the INVITE message 205 is sent to a SIP server of the SIP server platform 130; the SIP server of the SIP server platform 130, upon receipt of the INVITE message 205, sends an INVITE message 210 to the invited terminal 105b;
a 200 OK message 215 (including an SDP session description) generated by the invited terminal 105b as an answer to the received INVITE message 210, indicating that the terminal 105b accepts to set-up a communications session, and sent to a SIP server of the SIP server 130 platform; the SIP server of the SIP server platform 130, upon receipt of the 200 OK message 215, sends a 200 OK message 220 to the inviting terminal 105a;
a final ACK message 225, generated by the inviting terminal 105a in consequence to the receipt of the 200 OK message 220 for acknowledging this event to the invited terminal, sent to a SIP server of the SIP server platform 130, which forwards the ACK message 230 to the terminal 105b.

The exchange of the audio/video data 235 can start after the receipt by the terminal 105a of the 200 OK message 220. In particular, each of the two terminals 105a and 105b can start delivering audio/video data only after having received a message comprising an SDP session description: more specifically, the terminal 105a can start delivering audio/video data only after having received the 200 OK message 220, whereas the terminal 105b can start delivering audio/video data only after having received the INVITE message 210, or, preferably, after having sent the 200 OK message 215.

After the communications session set-up, the delivery of the audio/video data over an IP-based network involves several further protocols, at different layers of the OSI model, as negotiated through the SIP/SDP messages. The audio/video data are generally organized as streams of packets.

FIG. 3 schematically shows some exemplary protocol stacks that can be used to deliver the audio/video data; in particular, the protocols stacks are shown as divided in protocol layers above and below an IP interface 300. A usual stack 305 of protocols above the IP level includes (in descending order from the application layer towards the physical layer) the RTP, the UDP and the IP. As discussed in the foregoing and known to those skilled in the art, the RTP is an application-layer protocol that associates meta-information (timestamps, sequence numbers etc.) to each portion of the audio or video payload; the UDP is a transport-layer protocol that provides a transport service suitable for real-time delivery (data packets are sent once, and not acknowledged: thus, lost packets are not retransmitted, and new packets do not have to wait for retransmission of old ones); the IP is a network-layer protocol that provides the overall transport service infrastructure (addressing, routing etc.).

While in common implementations of real-time audio/video-communications the variety of protocol stacks above the IP level 300 is rather limited, the protocol stacks below the IP level 300 may greatly vary. For example, a point-to-point connection over a POTS line is a possibility, in which case a protocol stack 310 might be used, with a data link layer formed by the PPP (Point-to-Point Protocol) protocol on top of the LAP-M (Link Access Procedure for Modems) protocol, and a V.92 Modem data connection. Another possibility, indicated with 315 in the drawing, is a direct mapping onto a physical interface such as Ethernet. Several other protocol stacks are possible, generically indicated with 320 in the drawing.

Generally, each protocol layer introduces a respective protocol overhead on the exchanged data. The overhead due to the various protocol layers can be modeled as a per packet overhead, a per byte overhead, or a stepwise overhead.

A per packet overhead is encountered when the corresponding protocol layer takes into account the boundaries of the data packets coming from the upper protocol layer, and adds a certain overhead on each such data packet: in this case, the bigger the data packet, the lower the overhead percentage; examples or protocol layers that add a per packet overhead are the RTP, the UDP, the IP, and, below the IP interface level 300, the ETH and the PPP.

A per byte overhead is encountered, when the corresponding protocol layer ignores the boundaries of the data packets coming from the upper protocol layer, and manages the data traffic simply as a stream of bytes, to which it adds a certain average overhead. For example, the stream of bytes may be segmented into frames of a certain length (in terms of number of bytes), each frame having a header and/or a trailer (this is for example the case of the LAP-M protocol); alternatively, the stream of bytes may be coded according to some rule, e.g. escape bytes or bits may be inserted to avoid emulating certain sequences, whose occurrence can be statistically determined (this is for example again the case of the LAP-M protocol). In these two exemplary cases, the overhead can be modeled as a fixed overhead percentage.

A stepwise overhead is encountered, when the corresponding protocol layer takes into account the boundaries of the data packets coming from the upper layer, but encapsulates the data packets received from the upper level into frames of fixed length, adding padding bytes to fill the last frame assigned to the upper-layer data packet; this is for example the case of the ATM-AAL5 protocol (Asynchronous Transfer Mode Adaptation Layer 5, a known data link level protocol), where a data packet received from the upper layer is segmented to fit the payload space of an integral number of ATM cells, with padding in the last cell of 0 to 47 bytes.

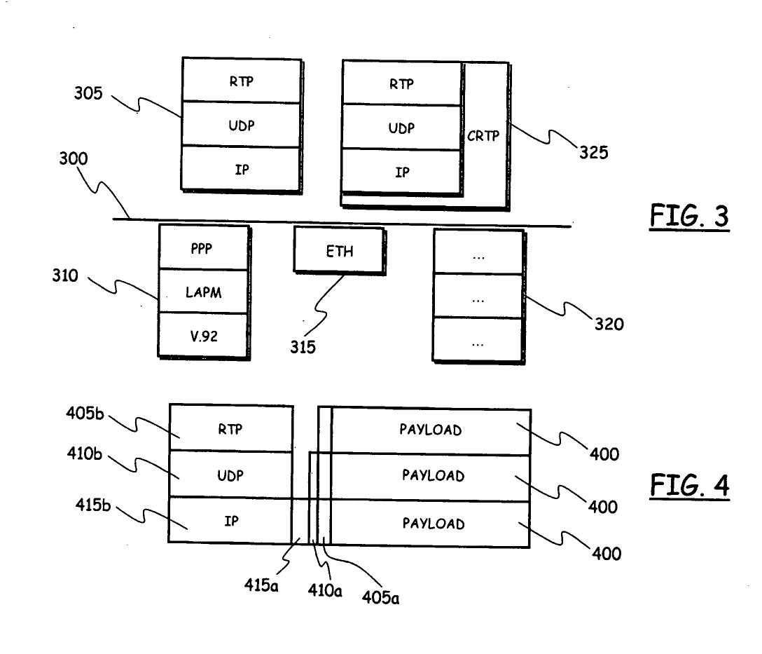

FIG. 4 shows in particular how the RTP/UDP/IP protocols stack contributes to the overhead of a single data packet. The data packet payload 400 is pre-pended first with a header 405a generated by the uppermost layer 405b of the protocols stack, in the example considered the RTP. Then, the data resulting from the juxtaposition of the payload 400 and the header 405a is further pre-pended with a header 410a generated by the next layer 410b of the protocol stack, in the example considered the UDP. Then, the data resulting from the juxtaposition of the headers 410a and 405a and the payload 400 is further pre-pended with a header 415a generated by the following layer 415b of the protocol stack, in the example considered the IP. In particular, the overhead introduced by the RTP/UDP/IP stack of layers is fixed and in the practice equal to 40 bytes. However, there may be cases where the overhead introduced by the RTP/UDP/IP stack of protocol layers is not fixed. This happens for example when IP tunneling is employed, that implies a sort of “double” IP layer, but introduces an extra overhead for each packet. Extra overhead might also relate to the adoption of encrypting techniques, such as IPSec (a standard for securing the IP communications by encrypting and/or authenticating all IP packets). Another technique used in some contexts is the compression of the RTP/UDP/IP headers 415a, 410a and 405a. The CRTP (Compressed RTP) or other similar techniques such as ECRTP (Enhanced CRTP) share the concept of “compressing” the RTP/UDP/IP headers when the variation in the contents of such headers among consecutive packets can be predicted: in such circumstances, the apparatus at one end of the link, e.g. the sender terminal 105a, only sends the minimum information needed by the apparatus at the other end of the link, e.g. an apparatus of the access network 110a, to rebuild the complete RTP/UDP/IP header. CRTP or ECRTP can only be applied on a link-by-link basis, and do not apply end-to-end. That is, CRTP or ECRTP are only used between two apparatuses that deal with the IP level, that are directly connected (i.e. there are no IP routers in between), and are CRTP/ECRTP enabled. In FIG. 3, reference numeral 325 denotes a schematization of the RTP/UDP/IP stack compressed with CRTP. By means of CRTP/ECRTP techniques, the overhead due to RTP/UDP/IP can be reduced from 40 bytes to 4 or 2 or even fewer bytes per packet.

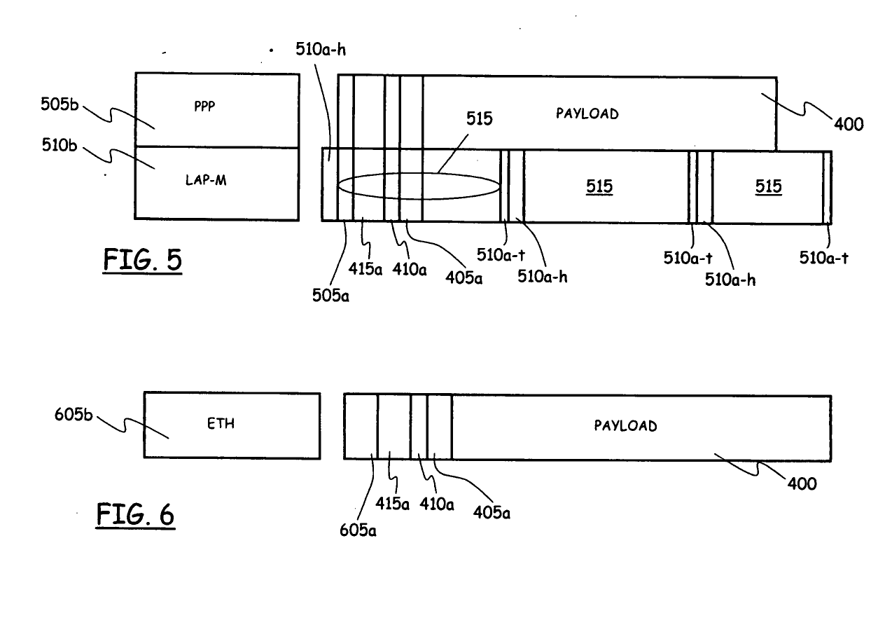

FIG. 5 shows how the PPP/LAP-M protocols stack below the IP interface level further contributes to the overhead of a single data packet received from the upper protocol stack. The data packet formed by the juxtaposition of the headers 415a, 410a and 405a and the payload 400 is further pre-pended with a header 505a generated by the uppermost layer 505b of the protocol stack below the IP level interface, in the example here considered the PPP. Then, the data packet formed by the headers 505a, 415a, 410a and 405a and by the payload 400 is segmented in smaller chunks, because the lower, data link layer 510b of this protocol stack, i.e. the LAP-M protocol, manages the data to be transmitted as a continuous flow of bits, not as packets, and reorganizes the traffic in segments of fixed length. It is pointed out that, for the sake of simplicity of illustration, in FIG. 5 a single data packet coming from the upper layer 505b is shown, while in the general case a series of data packets would be present, and the segmentation performed by the protocol layer 510b would simply ignore the boundaries in the data packets received from the upper layer. The protocol layer 510b adds to each data segment 515 both a header 510a-h and a trailer 510a-t. The full protocol stack of this example would then continue with the V.92 protocol layer, but for the sake of readability FIG. 5 avoids showing the additional overhead contributions.

FIG. 6 shows how the ETH stack further contributes to the overhead of a single data packet received from the upper protocol stack. The data packet formed by the juxtaposition of the headers 415a, 410a and 405a and the payload 400 is further pre-pended with a header 605a generated by the data link layer 605b of this protocol stack, in the example considered the Ethernet protocol layer.

According to an embodiment of the present invention, in order to enable the selection of the audio and the video coding and transmission parameters in a way adapted to fully exploit the limited bandwidth available, the sender terminal gathers from the recipient terminal, intended to act as the recipient of the audio/video flow(s), information useful to characterize the actual network bandwidth available for reception at the recipient terminal side of the audio/video flow(s) payload(s); the sender terminal then combines the information gathered from the recipient terminal with an indication of the network bandwidth available for transmission at the sender terminal's side, and assesses where the bandwidth bottleneck resides: the bottleneck may reside at the recipient terminal's side (in this case, the bottleneck is the useful bandwidth available for reception of the audio/video flow(s) payload(s)), or at the sender terminal's side (in this case, the bottleneck is the useful bandwidth available for transmission of the audio/video flow(s) payload(s). The encoding and transmission parameters for delivering the audio/video flow(s) are then calculated based on the assessed bandwidth bottleneck. Referring to the scenario depicted in FIG. 1, the sender terminal and the recipient terminal may be either one or both of the terminals 105a and 105b; in particular, in case of a bidirectional exchange of audio/video flows, both the terminals 105a and 105b may behave as both sender and recipient terminals.

Thus, according to an embodiment of the present invention, the recipient terminal is adapted to get, and then provide to the sender terminal, information useful to characterize the actual, useful network bandwidth available for reception of the audio/video flow(s) payload at its side, i.e. information about the characteristics of its downlink (DL) connection to the access and core networks; the sender terminal is adapted to gather from the recipient terminal said information, and to get information useful to characterize its uplink (UL) connection to the access and core networks, and to combine the latter information with the information about the DL of the recipient terminal.

In particular, according to an embodiment of the present invention, the recipient terminal, at least at the set-up of the real-time audio/video communications session, provides to the sender terminal a set of parameters useful to describe the communications network resources in DL, particularly the bandwidth availability of its DL connection, as perceived by the recipient terminal. By “communications network resources as perceived by the recipient terminal” it is meant that the recipient terminal perceives the communications network resources available for the reception of data from the transmitting terminal, i.e. the DL, in a way that is determined by several factors, including but not limited to the capabilities of the access network 110b: said factors include for example the recipient terminal capabilities, the presence of the home network 115b, its capabilities and the presence of traffic on it in addition to the traffic directed to the recipient terminal 105b and limiting the available bandwidth, characteristics of the link between the home network 115b (if any) and the access network 110b, characteristics of the link between the recipient terminal 105b and the home network 115b (if any), or of the link between the recipient terminal 105b and the access network 110b (if the terminal is directly connected thereto), etc.

In particular, according to an embodiment of the present invention, the set of parameters that the recipient terminal provides to the sender terminal includes an indication of the bandwidth available at a selected reference protocol layer in the protocol layer stack; alternatively or in combination, an indication is provided of the overall per-packet overhead introduced by the protocol layers from the application layer (e.g., above the RTP protocol) down to (and including) the selected reference layer.

The reference protocol layer can be selected autonomously by the recipient terminal; in principle, the reference protocol layer may be selected arbitrarily; for example, the reference protocol layer might be the uppermost protocol layer in the stack, like the application layer above the RTP layer. The choice of the reference protocol layer determines the way the per-packet overhead to be communicated to the sender terminal is calculated; for example, in case the reference protocol layer coincides with the uppermost protocol layer, the overhead is zero.

In general, the computation of the overhead introduced by the various protocol layers on an audio/video flow is not trivial.

In particular, the computation of the overhead induced by the protocol layers below the IP interface level 300 is quite complex. As discussed above, in some cases the data is physically streamed according to a framing mechanism totally decoupled from the IP packetization; in other cases, the IP packets boundaries are preserved, but adapted with extra padding to fit the physical frames. For example, the LAP-M protocol adopts a per byte overhead, whereas the ATM-AAL5 protocol is even more difficult to model, since the difference of 1 byte in the packet length at the application level might result in a full additional ATM cell (53 bytes).

According to a preferred embodiment of the present invention, in order to overcome problems in estimating the overhead introduced by the protocol layers stack, the reference protocol layer is selected as the lowest protocol layer in the whole stack that manages the data flow as a flow of packets, preserving the packet boundaries defined by the upper protocol layers, and not as a stream of bytes. For example, referring to FIGS. 3 to 6 and to the description in the foregoing, the reference protocol layer is the PPP layer, in the case depicted in FIG. 5, or the ETH layer in the case of FIG. 6. The estimated overhead that is communicated to the sender terminal is thus the overall per-packet overhead introduced by all the protocol layers in the protocols stack from the application layer above the RTP layer down to (and including) the reference layer. In case the selected reference protocol layer coincides with the application layer above the RTP layer, the overall per-packet overhead is equal to zero. It is observed that selecting a lower protocol in the stack as the reference protocol layer is advantageous, because the indication of bandwidth available at that protocol layer is more precise than in case an upper layer in the stack is selected as the reference protocol layer.

As discussed in the foregoing, the overhead introduced by the upper protocol layers down to and including the IP layer (i.e., down to the level of the IP interface 300) might, in some case, differ significantly from the figure of 40 bytes per packet given above; this may for example be the case when header compression is adopted: the header compression technique does not usually allow compressing all RTP/UDP/IP headers. According to an embodiment of the present invention, in such a case, an average value for the per-packet overhead can be used, deduced statistically.

In particular, in an embodiment of the present invention, the set of parameters that the recipient terminal provides to the sender terminal for describing the communication resources available at its side for reception of the audio/video flow(s) are communicated to the sender terminal at least during the session set-up. For example, as indicated in FIG. 2 by reference numerals 250 (e.g., the available bandwidth) and 255 (e.g., the overall per-packet overhead), these two parameters are included in the SDP description that is in turn transported by the 200 OK message 215 that the terminal 105b sends to the terminal 105a in reply to the INVITE message 210. It is observed that in case of bidirectional exchange of audio/video flow(s), the terminal 105a, which would act as the receiving terminal for the audio/video flow(s) sent by the terminal 105b, may include the parameters of available bandwidth and overall per-packet overhead useful to describe the bandwidth available at its side for reception of the audio/video flow(s) in the SDP description transported by the INVITE message 205 issued for setting-up the session (as indicated by reference numerals 260 and 265 in FIG. 2).

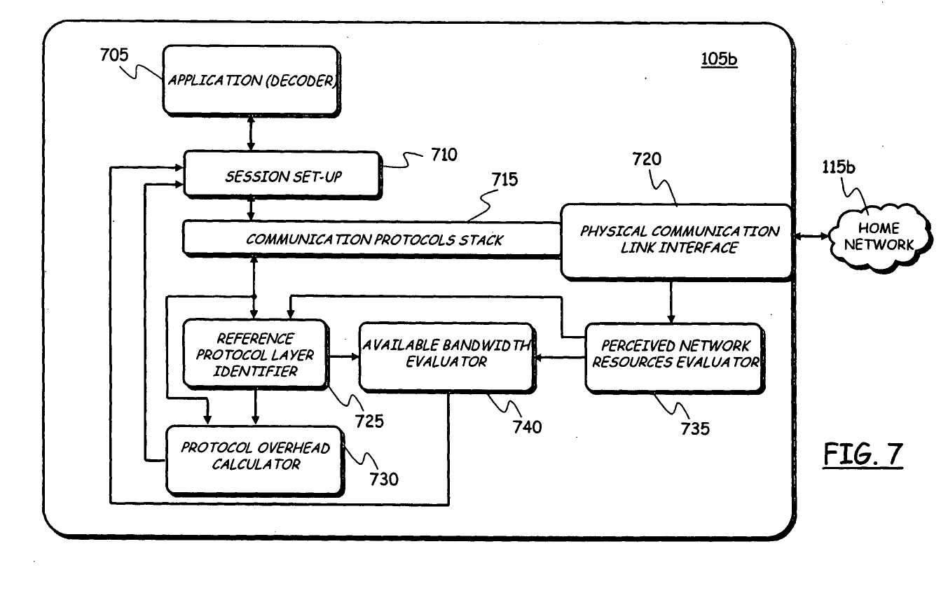

FIG. 7 schematically shows, in terms of functional blocks, the main functional components of a terminal intended to be the recipient of the audio/video flow(s), according to an embodiment of the present invention. Only the functional blocks essential for the understanding of the invention embodiment herein described are shown. It is also pointed out that any of the depicted functional blocks may in practice be implemented as pure hardware, pure software/firmware, or as a mix of hardware and software/firmware. For example, the terminal depicted in FIG. 7 may refer to the terminal 105b of FIG. 1. The terminal may include a data processing unit, like a CPU, with volatile and non-volatile memory resources, a keyboard, a display, typically of the liquid crystal type, a loudspeaker, a microphone, and, possibly, a videocamera (although in case the audio/video flow is unidirectional, the videocamera may be not essential). In some implementations, the terminal may include no input/output devices (for example, the terminal may be a server or a gateway).

A module 705 represents an application adapted to enable receiving and processing, e.g. reproducing the audio/video flow(s); the application module 705 includes in particular an audio codec and a video codec. A session set-up module 710 handles the set-up of a real-time audio/video-communication session, and is adapted to negotiate the session parameters with a sender counterpart. For example, the session set-up module 310 is adapted to carry out a SIP/SDP-based session set-up. A block 715 is intended to represent the stack of transport protocols down to the physical layer, and interacts with a physical link communications interface 720 handling the link with the home network 115b (or, in case the home network is absent, with the access network 110b).

According to an embodiment of the present invention, a module 725 is provided that is adapted to identify, among the protocol layers in the stack 715, the preferred protocol layer to be taken as the reference protocol layer; as discussed in the foregoing, the reference protocol layer can be the lowest protocol layer in the whole stack 715 that manages the data flow as a flow of packets, delimited by the upper protocol layers, and not as a stream of bytes. A protocol overhead calculator module 730 is adapted to estimate the overall per-packet overhead introduced by all the protocol layers in the stack 715 down to (and including) the selected reference protocol layer. Preferably, the protocol overhead calculator module 730 is adapted to independently estimate an overall per-packet overhead for the audio data packets and for the video data packets (it is pointed out that the two overhead values may differ, for example because the CRTP has a different impact on audio packets compared to video packets, or because different protocol stacks are used for audio and video). The protocol overhead calculator module 730 is also preferably adapted to determine whether some form of RTP compression is employed, and, in the affirmative case, to statistically derive an average overhead value. Preferably, respective average overhead value may be calculated for the data packets of the audio flow and for those of the video flow.

Also according to an embodiment of the present invention, a module 735 is provided that is adapted to evaluate the resources of the communications network at the receiving terminal side, as perceived by the receiving terminal. In particular, the module 735 is adapted to determine what is the network configuration at the receiving terminal side, e.g. whether the home network 105b is present, which is the bottleneck within its network configuration, e.g. whether the bottleneck resides in the link between the recipient terminal 105b and the access network 110b (if no home network exists), or in the link between the recipient terminal 105b and the home network 115b (for example a WiFi channel), or in the link between the home network router and the access network, or in the computational power of the terminal itself. In practice, the module 735 might combine a static knowledge of the terminal capabilities and of the home and access network configuration with a dynamic knowledge of parameters such as the bit rates negotiated by a POTS modem. The module 735 communicates the identified bottleneck to the reference protocol layer identifier module 725, so that the reference protocol layer is determined in respect of the identified bottleneck. Based on the indications received from the module 735 and the module 725, an available bandwidth evaluator module 740 calculates the available bandwidth at the selected reference protocol layer, i.e. the bandwidth available for carrying the audio or video payload plus the overhead added by all the protocol layers in the stack down to (and including) the reference protocol layer (e.g., all the protocol layers from the RTP down to the selected reference protocol layer, e.g. the PPP layer, in the example of FIG. 5).

The estimated available bandwidth at the selected reference protocol layer and the estimated overall per-packet overhead at that layer (preferably, estimated independently for the audio data packets and the video data packets) are provided to the session set-up module 710, so that it can include these parameters in the session description at the session set-up.

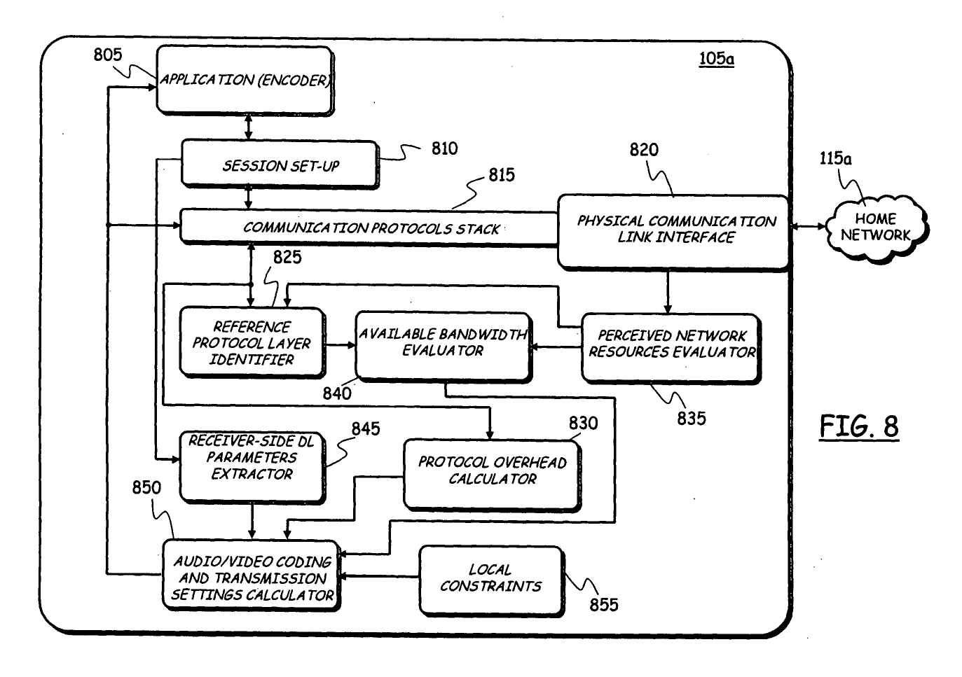

FIG. 8 schematically shows, in terms of functional blocks, the main functional components of a terminal intended to send the audio/video flow(s), according to an embodiment of the present invention. The terminal may for example be the terminal 105a of FIG. 1. Similar considerations about the nature of the functional blocks as made in connection with FIG. 7 apply. The terminal may include a data processing unit, like a CPU, with volatile and non-volatile memory resources, a keyboard, a display, typically of the liquid crystal type, a loudspeaker, a microphone, and, possibly, a videocamera. In some implementations, the terminal may include no input/output devices (for example, it may be a server or a gateway).

A module 805 represents an application adapted to generate audio/video flow(s), for example adapted to enable capturing audio and video from the microphone and the videocamera, and sending it to the receiving terminal; the application module 805 includes in particular an audio codec and a video codec. A session set-up module 810, similar to the module 710 of FIG. 7, handles the set-up of a video-communication session, and is adapted to negotiate the session parameters with a recipient counterpart. For example, the session set-up module 810 is adapted to carry out a SIP-based session set-up. Block 815 is intended to represent the stack of protocols down to the physical layer, and interacts with a physical link communications interface 820 handling the link with the home network 115a (or, in case the home network is absent, directly with the access network 110a).

According to an embodiment of the present invention, a module 825 is provided that is adapted to identify, among the protocol layers in the stack 815, the preferred protocol layer to be taken as the reference protocol layer; as discussed in the foregoing, the reference protocol layer is preferably the lowest protocol layer in the whole stack 815 that manages the data flow as a flow of packets, delimited by the upper protocol layers, and not as a stream of bytes. A protocol overhead calculator module 830 is adapted to estimate the overall per-packet overhead introduced by all the protocol layers in the stack 815 down to (and including) the selected reference protocol layer. Preferably, the protocol overhead calculator module 830 is adapted to independently estimate an overall per-packet overhead for the audio data packets and for the video data packets. The protocol overhead calculator module 830 is also preferably adapted to determine whether some form of RTP compression is employed, and, in the affirmative case, to statistically derive an average overhead value. Preferably, respective average overhead value may be calculated for the data packets of the audio flow and for those of the video flow.

Also according to an embodiment of the present invention, a module 835 is provided that is adapted to evaluate the resources of the communications network at the sender terminal side, as perceived by the sender terminal. In particular, the module 835 is adapted to determine what is the network configuration at the sender terminal side, e.g. whether the home network 105a is present, which is the bottleneck within its network configuration, e.g. whether the bottleneck resides in the link between the sender terminal 105a and the access network 110a (if no home network exists), or in the link between the sender terminal 105a and the home network 115a (for example a WiFi channel), or in the link between the home network router and the access network, or in the computational power of the terminal itself. In practice, the module 835 might combine a static knowledge of the terminal capabilities and of the home and access network configuration with a dynamic knowledge of parameters such as the bit rates negotiated by a POTS modem. The module 835 communicates the identified bottleneck to the reference protocol layer identifier module 825, so that the reference protocol layer is determined in respect of the identified bottleneck. Based on the indications received from the module 835 and the module 825, an available bandwidth evaluator module 840 calculates the available bandwidth at the selected reference protocol layer, i.e. the bandwidth available for carrying the audio or video payload plus the overhead added by all the protocol layers in the stack down to (and including) the reference protocol layer (e.g., all the protocol layers from the RTP down to the selected reference protocol layer, e.g. the PPP layer, in the example of FIG. 5).

A further module 845 is adapted to extract, from messages received from the recipient counterpart, e.g. the terminal 105b, for example during a real-time audio/video-communication session set-up phase, the parameters that describe the DL at the side of the recipient terminal. These parameters are provided to an audio and video coding and transmission parameters calculator module 850, which, based also on the knowledge of the local UL characteristics, is adapted to calculate the best audio and video coding and transmission settings that allow optimizing the exploitation of the available bandwidth; in particular, in an embodiment of the present invention, the calculation of module 850 also takes into account of local constraints 855 for the sender terminal.

The module 850 also receives from the modules 830 and 840 the calculated available bandwidth at the selected reference protocol layer and the estimated overall per-packet overhead at that layer (preferably, estimated independently for the audio data packets and the video data packets).

The calculated settings are provided to the application module 805 that accordingly sets the audio and video codecs, and to the communications protocols stack 815, that sets the proper transmission parameters for the audio/video flow(s).

It is observed that in case of bi-directional audio/video flows, the generic one of the two terminals 105a and 105b includes both the modules of FIG. 7, and those of FIG. 8.

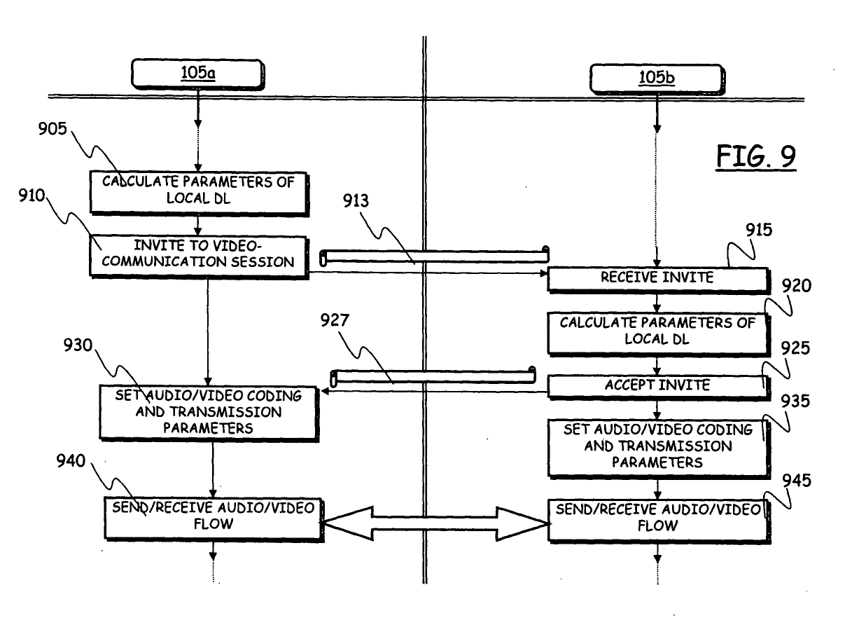

FIG. 9 is a schematic, simplified flowchart illustrating the main actions performed by the two terminals 105a and 105b for setting up a real-time audio/video-communication session.

Let it be assumed that the user of the terminal 105a wants to establish a real-time audio/video-communications session with the user of the terminal 105b; in particular, it is assumed that the audio/video-communications session to be established involves a bi-directional flow of audio/video data. Thus, for example before starting the session, the terminal 105a calculates the parameters useful to describe its own DL (block 905); in particular, these parameters, that in an embodiment of the present invention include the estimated available bandwidth at the selected reference protocol layer and the total audio and video per-packet overhead at that reference protocol layer, will be communicated to the terminal 105b, which will use them for determining the audio and video coding and transmission parameters to be used in sending the audio/video flow(s) to the terminal 105a.

Then, the terminal 105a sends to the terminal 105b an invitation 913 to the audio/video-communications session (block 910); for example, referring to FIG. 2, this involves sending to the SIP server 130 the INVITE message 205, carrying the SDP description, and including in the description the parameters 260, 265 describing the DL of the terminal 105a.

The terminal 105b receives the invitation (block 915), and calculates the parameters (the estimated available bandwidth at the selected reference protocol layer and the total audio and video per-packet overhead at that reference protocol layer) useful to describe its own DL (block 920).

The terminal 105b then replies to the invitation accepting to establish the video-communication session (block 925); to this purpose, the terminal 105b sends to the terminal 105a a reply 927 to the invitation 913, carrying the SDP description, and including in the description the parameters 250, 255 describing the DL of the terminal 105b; for example, referring to FIG. 2, this involves sending the 200 OK message 210.

Based on the parameters received from the terminal 105b and describing the DL thereof, and on the information describing the characteristics of its own UL, the terminal 105a calculates the audio and video coding and transmissions settings to be used in the video-communication session, and accordingly sets the audio and video codec (block 930). Similar actions are performed by the terminal 105b (block 935).

The two terminals 105a and 105b can thus start exchanging audio and video flows (blocks 940 and 945).

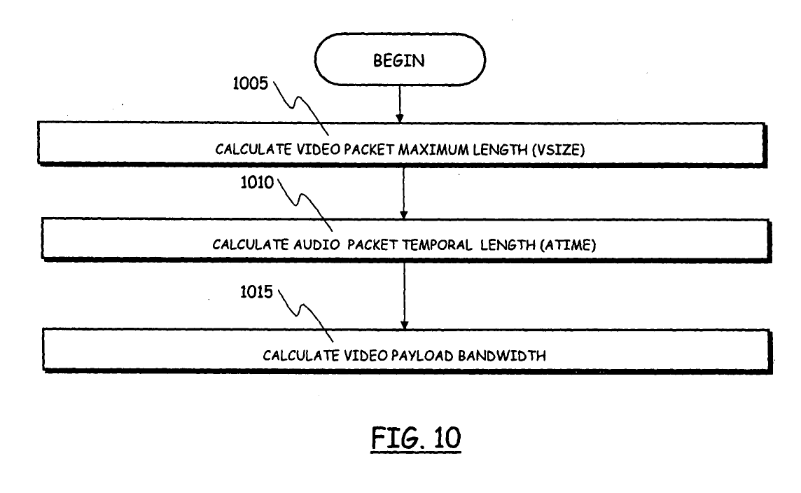

In FIG. 10, a schematic flowchart is provided of a possible algorithm for calculating the audio/video coding settings, according to an embodiment of the present invention, which is particularly adapted to the case of transmission of an audio and a video flows.

In particular, according to an embodiment of the present invention, two audio/video coding parameters are identified that affect the packetization of the audio/video data, are related with the calculation of the overhead, and impact on the overall quality; the exemplary algorithm depicted in FIG. 10 is directed to calculating said two audio/video coding parameters.

A first, audio coding parameter, is denoted “audio packet temporal length” (for example, in ms). Audio codecs define audio frames as the coded representation of a fixed number of audio samples, sampled at a certain sampling rate. The typical temporal length of an audio frames is for example 10 ms (in G729 codecs), 20 ms (in AMR codecs), or 30 ms (in G723 codecs). Except for silence coding optimization, the audio codecs normally generate audio frames having a fixed length (expressed in bytes), for each particular coding bitrate; one or more audio frames can be packed together at the application level, before being sent through the protocol stack (RTP/UDP/IP/ . . . ); this is explicitly considered in the RTP specifications. Thus, once the audio coding parameters are known, it is possible to correlate the audio payload length of every single RTP audio packet and the temporal length in ms of the corresponding audio signal contained in that packet; this temporal length is the parameter herein defined “audio packet temporal length”.

The longer the audio packet temporal length, the lower in percentage the overhead (since many protocol layers add per-packet overhead, as described above), but the bigger the audio end-to-end delay; this delay is a very sensitive quality parameter in communication services.

A second, video coding parameter, is denoted “video packet maximum length”. As known to those skilled in the art, video codecs normally encode video frames with significantly variable sizes. The fact that the number of bytes employed for encoding a video frame can significantly vary makes the overhead computation difficult (since many protocol layers add per-packet overhead, as described above). RTP rules allow splitting a single video frame into multiple RTP packets, whereas the concatenation of multiple small video frames into a single RTP packet is either prohibited (for some codecs) or anyway of little interest in the context of telecommunications (because the end-to-end delay would be significantly increased).

When a limited bandwidth is available for video-communications, such as in the case one or both of the terminals 105a a 105b includes or exploits a POTS network modem running at about 30 Kbit/s, the serialization time involved by a big RTP packet might become very relevant by way of example, 1000 bytes at 30 Kbit/s take approximately 266 ms. In an audio-video communication service over such a limited bandwidth link, audio packets and video packets would share the same path, so that the serialization time of a video packet directly contributes to the jitter suffered by the audio packets along that same path. The audio jitter perceived at the receiving entity contributes in turn to the end-to-end delay, since it has to be absorbed by a delay chain. In order to reduce the audio jitter induced by the interleaving of audio and video packets, and thus to reduce the audio end-to-end delay, the sending terminal should avoid generating large RTP video packets, with a length exceeding a certain, predetermined threshold; the “video packet maximum length” (for example, in Bytes) is the threshold expressing the maximum video packet length; large video frames should be split into multiple but separate RTP packets, so as to enable a finer interleaving with audio.

The bigger the video packet maximum length, the lower in percentage the overhead (since many protocol layers add per-packet overhead, as described above), but the bigger the audio end-to-end delay.

For both the two coding parameters defined above, the sender terminal should determine the better compromise between audio end-to-end delay and overhead. To this purpose, the sender terminal should be able to compute the overhead induced by the various possible choices with a sufficient precision.

According to an embodiment of the present invention, in order to calculate the audio packet temporal length and the video packet maximum length, the sender terminal exploits both the information describing the DL at the recipient terminal's side (i.e., the peer's receiving network bandwidth characteristics), and the information describing the local transmitting network bandwidth characteristics (i.e., the UL). Additionally, further (locally available) information about application/service constraints is exploited.

In particular, in an embodiment of the present invention, the following constraints are used for calculating the audio packet temporal length (hereinafter also referred to as “ATIME”) and the video packet maximum length (also referred to as “VSIZE”) parameters defined above, as well as the video payload bandwidth (VBW) resulting from the calculated ATIME and VSIZE:
minimum (“MIN_ATIME”) and maximum (“MAX_ATIME”) allowed values for the audio packet temporal length;
maximum value (“MAX_VSIZE”) for the video packet maximum length (for example reflecting the MTU—Maximum Transfer Unit—size, a parameter that, for a given IP-based network, sets a limit to the size of the RTP data packets);
minimum value (“MIN_VBW”) for the video payload bandwidth;
audio payload bandwidth (“ABW”); and
maximum amount of interleaving jitter (“MAX_JITTER”) that might be induced on the audio stream by interleaving audio and video packets.

The characteristics of the receiving network locally to the recipient terminal, i.e., as discussed in the foregoing, the available bandwidth at the reference protocol layer, and the overall per-packet overhead at the reference protocol layer, communicated by the recipient terminal to the sender terminal during the session set-up, are hereinafter labeled as “TIDC” (“Transport-Independent Downlink Capacity”) and MPODA/V (“Mean Packet Overhead for Downlink Audio/Video”); it is observed that in some practical cases, the MPODA/V (which preferably are two values, one related to the audio flow, the other related to the video flow) express the precise overhead, whereas in other cases it can be an average calculated statistically.

The bandwidth characteristics of the local transmitting network locally to the sender terminal, i.e. the available bandwidth at the reference protocol layer, and the overall per-packet overhead at the reference protocol layer, are hereinafter labeled as “TIUC” (“Transport-Independent Uplink Capacity”) and “MPOUA/V” (“Mean Packet Overhead for Uplink Audio/Video”) (also in this case, two per-packet overhead values are provided, one related to the audio flow, the other related to the video flow).

Referring to FIG. 10, in a first phase (block 1005) the parameter VSIZE is computed. The serialization time of a video packet is computed as a function of the maximum packet size. Such serialization time provides an almost precise approximation of the interleaving jitter that might be induced on the audio stream due to the interleaving with video packets. As such, by applying the constraint expressed by the value MAX_JITTER, and taking into account the constraint expressed by the value MAX_VSIZE, the value for the parameter VSIZE is determined.

In a second phase (block 1010) the parameter ATIME is computed. The constraint expressed by MIN_VBW is used to calculate, in combination with the parameter VSIZE determined in the first phase, the minimum amount of bandwidth that shall be guaranteed to the video flow (payload and overhead). The bandwidth available for audio overhead is then calculated by subtracting from the indication of the available bandwidths (at the reference protocol layer) for the DL at the recipient terminal side and the UL at the sender terminal side the bandwidth contributions to be dedicated to the audio payload (constraint expressed by ABW), to the video payload (constraint expressed by MIN_VBW) and to the video overhead (a function of the parameters MIN_VBW, VSIZE and MPODV/MPOUV). This computation is done for both the UL local to the sender terminal and the DL at the recipient terminal side, so as to identify where the bottleneck resides (in terms of useful bandwidth for transmitting and receiving the audio and video flows payloads) and the lower value is selected as a constraint for the maximum bandwidth that can be dedicated to the audio overhead. Then, the parameter ATIME is set to the lowest possible value, within the range delimited by the parameters MIN_ATIME and MAX_ATIME, that would cause an audio overhead bandwidth not exceeding the constraint calculated above.

Finally, in a third phase (block 1015) the parameter VBW is computed. The bandwidth available for the video is calculated by detracting from the indication of the available bandwidths (at the reference protocol layer) for the DL at the recipient terminal side and the UL at the sender terminal side the bandwidth contributions to be dedicated to the audio payload (ABW) and to the audio overhead (calculated by means of the parameters ATIME determined in the second phase, in combination with the parameters MPODA/MPOUA). Taking into account the parameter VSIZE determined above, as well as the parameters MPODV/MPOUV, the percentage of video bandwidth to be dedicated to the overhead is computed, and the actual available bandwidth for the video payload is derived. These computations are replicated for both the local uplink and the remote downlink: the lower value obtained for the video payload bandwidth is selected as the VBW.

The parameters VSIZE, ATIME and VBW thus obtained are used to set the audio and video coding and transmission parameters at the sender terminal side.

Hereinbelow, a numeric example is provided for better clarifying the algorithm described above. Let it be assumed that an audio and video communication session is being set up between two terminals, one connected through a PSTN modem and one connected through ADSL: the bottleneck in this scenario is at the side of the terminal connected through the PSTN modem. Let it be assumed that the gross bandwidth available (in DL, in particular) at the PSTN modem side is 33 Kbit/s. Let it also be assumed that the selected audio codec is G.723, in 5.3 Kbit/s mode. This codec generates audio frames 30 ms long and of 20 bytes in size, meaning 33.3 audio frames per second, and therefore consumes a net bandwidth of 5333 bit/s. The sender should be put in condition of setting the encoding and transmission parameters so as to maximize the quality of the end user experience. Relevant criteria are the audio end-to-end delay and the net video bandwidth.

The reference protocol layer selected at the receiver side is the PPP layer. The set of parameters that the receiver terminal provides to the sender terminal includes an indication of the bandwidth available at the selected reference protocol layer (the parameter named TIDC in the above description) and of the overall per-packet overhead introduced by the protocol layers down to (and including) the selected reference layer, for both audio and video flows (the parameters named MPODA and MPODV in the above description).

Based on the figures given in this example, the parameter TIDC is calculated as 33 Kbit/s less the LAPM overhead. The result is about 30 Kbit/s. The per-packet overhead depends on the protocol stack: if the protocol stack above the IP layer is the stack denoted 305 in FIG. 3, the per-packet overhead is 47 Bytes (12 Bytes for RTP overhead, 8 bytes for UDP, 20 bytes for IP, 7 bytes for PPP); if instead the protocol stack above the IP layer is the stack denoted 325 (with compression), the per-packet overhead is about 11 Bytes (4 Bytes for CRTP, 7 Bytes for PPP).

When the sender terminal receives from the recipient terminal an indication containing <TIDC=30, MPOD=47>, the sender terminal shall set its own encoding and transmission parameters quite differently from those that it would set in case the indication had contained <TIDC=30, MPOD=11>.

Indeed, in case of a normal RTP stack (305), the audio overhead that is associated to RTP packets each containing, e.g., 1 or 4 audio frames (ATIME=30 or ATIME=120) would be, respectively:

ATIME=30→(47*8*33.3)=12.53 Kbit/s

ATIME=120→(47*8*8.3)=3.13 Kbit/s

Thus, an increase in the audio end-to-end delay due to the transmission of bigger packets (120 ms instead of 30 ms) would lead to a significant save in bandwidth (9.4 Kbit/s), that can therefore be dedicated to the video portion; this would lead to a significant increase of the gross video bandwidth, that would pass from about 12.1 Kbit/s (30-5.33-12.53) to about 21.5 Kbit/s (30-5.33-3.13). The net video bandwidth would benefit in proportion, and thus the sending terminal might decide to accept a higher audio end-to-end delay in order to nearly double the video bandwidth and, ultimately, the video quality.

Instead, in case of a Compressed RTP stack (325), the audio overhead that is associated to RTP packets each containing, e.g., 1 or 4 audio frames (ATIME=30 or ATIME=120) would be, respectively:

ATIME=30→(11*8*33.3)=2.93 Kbit/s

ATIME=120→(11*8*8.3)=0.73 Kbit/s

Thus, an increase in the audio end-to-end delay due to the transmission of bigger packets (120 ms instead of 30 ms) would lead to a quite lower saving in bandwidth (2.2 Kbit/s). The benefits on the video bandwidth (that would pass from about 21.7 Kbit/s to about 23.9 Kbit/s) would be much less valuable, and therefore the sending terminal would likely decide not to worsen the audio end-to-end delay for such a poor increment in the video quality.

It is pointed out that should the sending terminal be unaware of the per-packet overhead at the receiving end, prudent guesses would have to be made, and thus the sending terminal should assume a stack such as the one indicated as 305 (without CRTP). As a consequence, even if Compressed RTP had been in place, such advantage would have not been fully exploited.

Thanks to the present invention, an efficient exploitation of the available bandwidth for a real-time audio/video communications session is made possible; this is particularly important in all those cases wherein the bandwidth resources are limited, such as in the case of video-telephony over POTS networks, and generally whenever the bandwidth does not exceed approximately 40-50 Kb/s, particularly 25-30 Kb/s.

It is pointed out that although in the foregoing reference has been made, by way of example, to the case of two video-communication terminals, particularly videophones, this is not to be construed as a limitation of the present invention, which applies in general whenever a sending entity, acting as a sender of the audio/video flow(s), and a receiving entity, intended to receive the audio/video flow(s), can be identified. In order to enable the sending entity to select the audio and the video coding and transmission parameters in a way adapted to efficiently exploit the limited bandwidth available, the sending entity gathers from the receiving entity information useful to characterize the actual network bandwidth available for reception at the receiving entity side; the sender entity then combine the information gathered from the recipient entity with an indication of the network bandwidth available for transmission at its side, and assesses where the bottleneck resides: the encoding and transmitting parameters for delivering the audio/video flow(s) are then calculated based on the assessed bottleneck.

The present invention has been disclosed by describing an exemplary embodiment thereof, however those skilled in the art, in order to satisfy contingent needs, will readily devise modifications to the described embodiment, as well as alternative embodiments, without for this reason departing from the protection scope defined in the appended claims.

For example, nothing prevents that the receiving entity periodically evaluates the bandwidth locally available for reception, and communicates it to the sending entity, so as to update, if necessary, the audio/video coding and transmission parameters for tracking possible bandwidth changes.

Also, in alternative embodiments of the invention, instead of sending the per-packet overhead at the selected reference protocol layer, the receiving entity may send an indication of which is the protocol layer adopted as a reference, and at which the calculated bandwidth relates; in this case, the receiving entity calculates on its side the per-packet overhead experienced by the receiving entity.

Furthermore, as already pointed out in the foregoing, the knowledge of the overhead introduced by the communications protocol used by the sending entity, and, possibly, the overhead introduced by the communications protocol used by the sending entity, may be more important for the sending entity than the information about the actual available downlink bandwidth; this is for example the case of combined audio and video flows.

1-34. (canceled)

35. A method of sending a data flow comprising a video flow from a sending entity to a receiving entity over a telecommunications network, comprising having the sending entity:
obtain from the receiving entity information about a downlink bandwidth available for reception of the data flow at the receiving entity side;
obtain information about an uplink bandwidth available for the transmission of the data flow at the sending entity side;
set transmission parameters of the data flow to be sent to the receiving entity based on the information about the available downlink bandwidth and the available uplink bandwidth; and
transmit the data flow in accordance with the set transmission parameters.

36. The method of claim 35, further comprising at least one among:
obtaining from the receiving entity an indication of an overall per-packet overhead introduced by a communication protocol used by the receiving entity for receiving said data flow; and
obtaining an indication of an overall per-packet overhead introduced by a communication protocol used by the sending entity for transmitting the data flow.

37. The method of claim 36, wherein obtaining from the receiving entity information about the available downlink bandwidth comprises:
obtaining from the receiving entity an indication of an available bandwidth at a first reference protocol layer in a first stack of protocol layers used for receiving the data flow at the receiving entity.

38. The method of claim 37, wherein obtaining from the receiving entity the indication of the overall per-packet overhead comprises:
obtaining an indication of an overall per-packet overhead introduced by protocol layers in said first stack of protocol layers and comprising a first reference protocol layer.

39. The method of claim 37, wherein said first reference protocol layer is selected as a lowest protocol layer in the first stack that manages the data flow as a flow of data packets.

40. The method of claim 35, wherein obtaining information about the available uplink bandwidth comprises:
obtaining an indication of an available bandwidth at a second reference protocol layer in a second stack of protocol layers used for transmitting the data flow to the receiving entity.

41. The method of claim 40, wherein obtaining the indication of the overall per-packet overhead introduced by the communication protocol used by the sending entity comprises:
obtaining an indication of an overall per-packet overhead introduced by protocol layers in said second stack of protocol layers and comprising a second reference protocol layer.

42. The method of claim 40, wherein said second reference protocol layer is selected as a lowest protocol layer in the second stack that manages the data flow as a flow of data packets.

43. The method of claim 35, wherein obtaining from the receiving entity information about the available downlink bandwidth comprises receiving said information from the receiving entity during a communications session set-up.

44. The method of claim 43, wherein said information about the available downlink bandwidth is in a session description embedded in a message received from the receiving entity at the session set-up.

45. The method of claim 44, wherein said message is a session initiation protocol or a message in response to an invite message sent from the sending entity.

46. The method of claim 35, wherein said transmission parameters comprise a maximum length of the packets of the video flow.

47. The method of claim 35, wherein said data flow further comprises an audio flow and wherein said transmission parameters comprise a temporal length of packets of the audio flow.

48. The method of claim 35, further comprising setting coding parameters of the data flow to be sent to the receiving entity based on the information about the available downlink bandwidth and the available uplink bandwidth, said coding parameters comprising a video payload bandwidth.

49. A sending entity capable of being adapted to send a data flow comprising a video flow to a receiving entity over a telecommunications network, the sending entity being adapted to:
obtain from the receiving entity information about a downlink bandwidth available for reception of the data flow at the receiving entity side;
obtain information about an uplink bandwidth available for the transmission of the data flow at the sending entity side;
set transmission parameters of the data flow to be sent to the receiving entity based on the information about the available downlink bandwidth and the available uplink bandwidth; and
transmit the data flow in accordance with the set transmission parameters.

50. The sending entity of claim 49, capable of being further adapted to perform at least one among:
obtain from the receiving entity an indication of an overall per-packet overhead introduced by a communication protocol used by the receiving entity for receiving said data flow; and
obtain an indication of an overall per-packet overhead introduced by a communication protocol used by the sending entity for transmitting the data flow.

51. The sending entity of claim 50, capable of being further adapted to:
obtain from the receiving entity an indication of an available bandwidth at a first reference protocol layer in a first stack of protocol layers used for receiving the data flow at the receiving entity.

52. The sending entity of claim 51, capable of being further adapted to:
obtain an indication of an overall per-packet overhead introduced by protocol layers in said first stack of protocol layers and comprising a first reference protocol layer.

53. The sending entity of claim 51, wherein said first reference protocol layer is selected as a lowest protocol layer in the first stack that manages the data flow as a flow of data packets.

54. The sending entity of claim 50, capable of being further adapted to:
obtain an indication of an available bandwidth at a second reference protocol layer in a second stack of protocol layers used for transmitting the data flow to the receiving entity.

55. The sending entity of claim 54, capable of being further adapted to:
obtain an indication of an overall per-packet overhead introduced by protocol layers in said second stack of protocol layers and comprising the second reference protocol layer.

56. The sending entity of claim 54, wherein said second reference protocol layer is selected as a lowest protocol layer in the second stack that manages the data flow as a flow of data packets.

57. The sending entity of claim 49, capable of being further adapted to obtain from the receiving entity said information about the available downlink bandwidth during a communications session set-up.

58. The sending entity of claim 57, wherein said information about the available downlink bandwidth is in a session description embedded in a message received from the receiving entity at the session set-up.

59. The sending entity of claim 58, wherein said message is a session initiation protocol message or a message in response to an invite message sent from the sending entity.

60. The sending entity of claim 49, wherein said transmission parameters comprise a maximum length of the packets of the video flow.

61. The sending entity of claim 49, wherein said data flow further comprises an audio flow and wherein said transmission parameters comprise a temporal length of packets of the audio flow.

62. The sending entity of claim 49, capable of being further adapted to set coding parameters of the data flow to be sent to the receiving entity based on the information about the available downlink bandwidth and the available uplink bandwidth, said coding parameters comprising a video payload bandwidth.
